(19) United States
(12) Patent Application Publication
(10) Pub. No.: US 2016/0316645 A1
(43) Pub. Date: Nov. 3, 2016

(54) HYDROPONIC SYSTEM

(71) Applicant: Jon Neufeld, Des Moines, IA (US)

(72) Inventor: Jon Neufeld, Des Moines, IA (US)

(21) Appl. No.: 15/141,432

(22) Filed: Apr. 28, 2016

Related U.S. Application Data
(60) Provisional application No. 62/153,570, filed on Apr. 28, 2015.

(51) Int. Cl. A01G 31/02

(52) U.S. Cl. CPC A01G 31/02

(57) ABSTRACT

A hydrophobic system is presented having a stand with a base and a frame, a growing tube wrapped around the stand having a plurality of opening and a hose extending through the length of the growing tube.

### CROSS-REFERENCE TO RELATED APPLICATIONS

This application claims priority to Provisional Application U.S. Ser. No. 62/153,570 filed on Apr. 28, 2015 which is herein incorporated by reference in its entirety.

### FIELD OF THE INVENTION

This invention relates generally to a hydroponic system. More specifically, and without limitation, this invention relates to a hydroponic system used to grow plants.

### BACKGROUND OF INVENTION

Conventionally, plants are cultivated by placing the root systems in soil. While cultivating plants in this manner is certainly effective, planting plants in soil has its deficiencies. Namely, growth of the plants may he limited by the nutrients contained within the soil. While the nutrients within the soil can be modified by the application of additional constituents, such as fertilizers, due to the complex composition of many soils, it is difficult or impossible to accurately control and adjust the nutrient levels within soil to precisely meet the needs of growing plants. As a result, the development of plants grown under these conditions often fail to achieve their potential.

An improvement to growing plants in soil is known as hydroponics or hydroculture, which is a method of growing plants in a solution of water and nutrients and without soil. Hydroponically growing plants allows for precise control of the nutrients made accessible to the plants. As a result, plants grown hydroponically can out pace those grown conventionally in soil.

While hydroponically growing plants allows for improved growth and development, hydroponically growing plants presents certain challenges. Namely, a hydroponic system is needed to hydroponically grow plants. While many hydroponic systems have been developed over the years each suffer from substantial deficiencies. Namely, prior art hydroponic systems suffer from the disadvantages of being: expensive. complicated, inefficient, difficult to use, inconvenient to use, unattractive, among countless other disadvantages.

Therefore, for the reasons stated above, and for other reasons stated below which will become apparent to those skilled in the art upon reading and understanding the specification, there is a need in the art for an improved hydroponic system an.

Thus, an object of the invention is to provide an improved hydroponic system that improves upon the present state of the art.

Another object of the invention is to provide an improved hydroponic system that grows high quality plants.

Yet another object of the invention is to provide an improved hydroponic system that optimizes plant growth.

Another object of the invention is to provide an improved hydroponic system that is easy to use.

Yet another object of the invention is to provide an improved hydroponic system that is aesthetically pleasing.

Another object of the invention is to provide an improved hydroponic system that is efficient to use.

Yet another object of the invention is to provide an improved hydroponic system that can be used to grow multiple plants at a time.

Another object of the invention is to provide an improved hydroponic system that allows for easy control of nutrient levels.

Yet another object of the invention is to provide an improved hydroponic system that applies nutrient rich fluid in an efficient manner to the roots of plants.

Another object of the invention is to provide an improved hydroponic system that is relatively inexpensive.

Yet another object of the invention is to provide an improved hydroponic system that has a unique design.

Another object of the invention is to provide an improved hydroponic system that has a minimum number of parts.

Yet another object of the invention is to provide an improved hydroponic system that is convenient to use.

Another object of the invention is to provide an improved hydroponic system that is self-standing.

Yet another object of the invention is to provide an improved hydroponic system that is modular and can be expanded.

Another object of the invention is to provide an improved hydroponic system that has an intuitive design.

Yet another object of the invention is to provide an improved hydroponic system that is inexpensive to use.

Another object of the invention is to provide an improved hydroponic system that operates using and harnesses the benefits of both Nutrient Film Technique (N.F.T.) and Aeroponics.

Yet another object of the invention is to provide an improved hydroponic system that is inexpensive to use.

These and countless other objects, features, or advantages of the invention will become apparent from the specification and claims.

### SUMMARY OF THE INVENTION

A hydroponic system is presented having a stand with a base and a frame. A growing tube is supported by the stand and wraps around the stand as it extends at a downward angle before fluidly connecting to reservoir. The growing tube includes a plurality of openings in an upward facing surface which receive plants therein. A pump is fluidly connected to the reservoir and a hose. The hose extends through a length of the growing tube and includes a nozzle adjacent the openings such that when supplied with pressurized nutrient rich water from the pump the hose sprays the root systems of the plants. In this way, the hydroponic system harnesses the benefits of Aeroponics as well as Nutrient Flow Technique (N.F.T.).

### BRIEF DESCRIPTION OF THE DRAWINGS

FIG. 1 is a perspective view of a hydroponic system; and

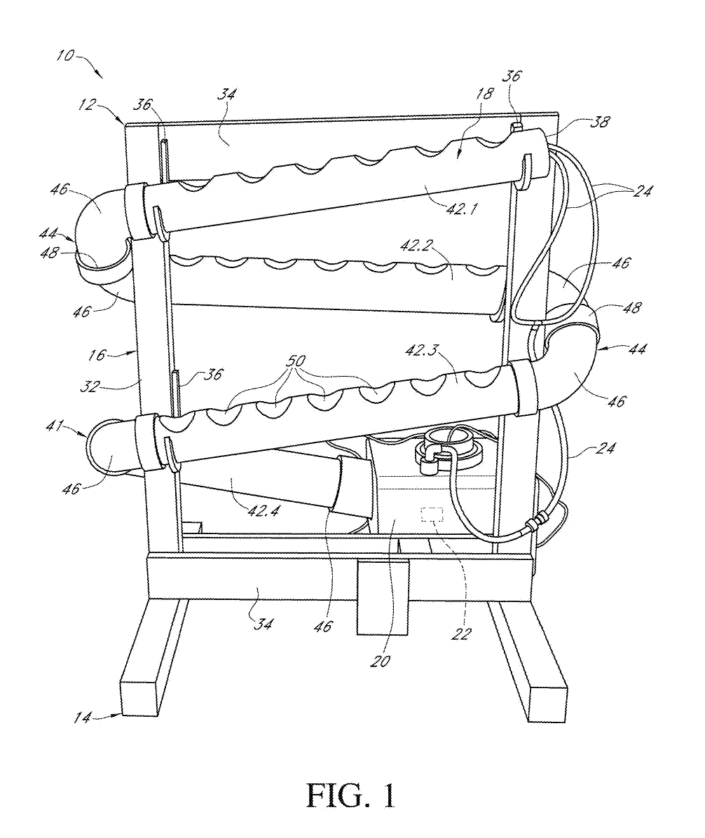

FIG. 2 is a side sectional view of a hydroponic system.

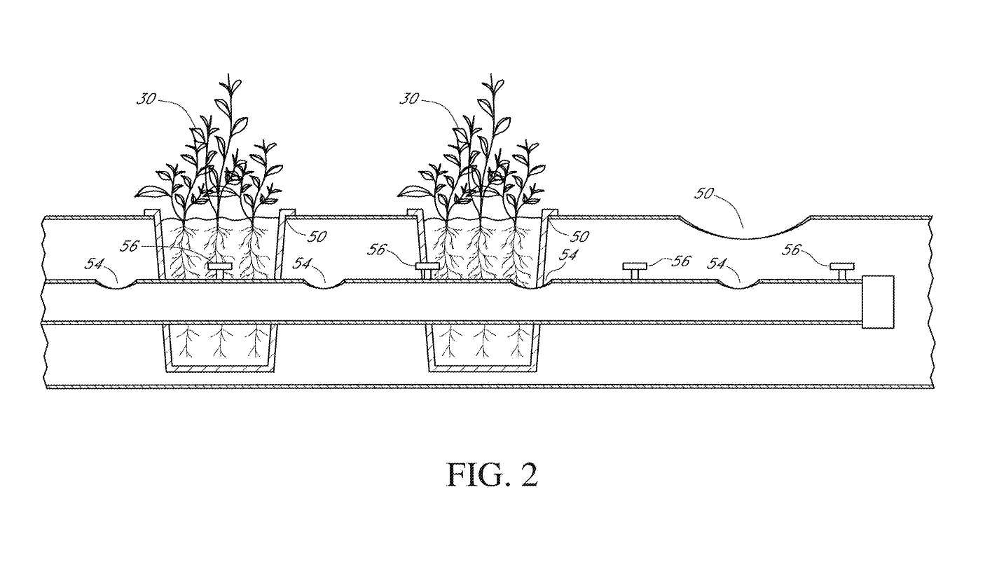

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that mechanical, procedural, and other changes may be made without departing from the spirit and scope of the invention(s). The following detailed description is, therefore, not to be taken in a limiting sense, and the scope of the invention is defined only by the appended claims, along with the full scope of equivalents to which such claims are entitled.

As used herein, the terminology such as vertical, horizontal, top, bottom, front, back, end and sides are referenced according to the views presented or orientation of parts. It should be understood, however, that the terms are used only for purposes of description, and are not intended to be used as limitations. Accordingly, orientation of an object or a combination of objects may change without departing from the scope of the invention.

With reference to the Figures, a hydroponic system 10 is presented. The hydroponic system 10 is formed of any suitable size, shape and design. In one arrangement, as is shown, the hydroponic system 10 includes a stand 12 having a base 14 and a frame 16. A growing tube 18 is connected to and supported by the stand 12. A reservoir 20 is connected to a lower end of the growing tube 18 and includes a pump 22 connected to a hose 24. Hose 24 extends through growing tube 18 and includes a plurality of nozzles 26 therein that spray water onto the root systems 28 of plants 30 held within the growing tube.

Stand 12 is formed of any suitable size, shape and design. Stand 12 serves the purpose of supporting the hydroponic system 10. In one arrangement, as is shown, stand 12 includes a base 14 that is connected to and generally extends outwardly from the lower end of frame 16. In the arrangement shown, as one example, base 14 is formed of a pair of legs connected to opposing ends of the lower end of frame 16, these legs are positioned in approximate parallel spaced relation to one another, and are positioned in approximate perpendicular alignment to frame 16 which extends vertically upwardly therefrom. It is hereby contemplated that base 14 can be formed of any other suitable size, shape or design.

In one arrangement, as is shown, frame 16 is generally square or rectangular in shape and is formed of a pair of opposing side frame members 32 that are positioned in approximate parallel spaced relation to one another, and a pair of opposing end frame members 34 that are positioned in approximate parallel spaced relation to one another. Side frame members 32 and end frame members 34 are positioned in approximate perpendicular alignment to one another thereby forming a generally square or rectangular frame 16 having an open interior. End frame members 34 connect at their outward ends adjacent the upper ends and lower ends of side frame members 32. In the arrangement shown, one end frame member 34 is connected to either side of the lower end of side frame members 32, just above where base 12 connects to the lower end of side frame members 32. In contrast, only a single end frame member 34 is connected to the upper ends of side frame members 32. By connecting a pair of end frame members 34 to the side frame members 32 at the lower end of frame 16, this increases the strength and rigidity of the frame 16. It is contemplated to use a single or double end frame member 34 on either or both the top end or bottom end of side frame members 32. It is also hereby contemplated that frame 16 can be formed of any other suitable size, shape or design.

A plurality of hooks 36 are connected to frame 16. Hooks 36 are any form of hook member or other supporting device and are used to connect growing tube 18 to frame member 16. In the arrangement shown, hooks 36 connect to the side frame members 32 adjacent where growing tube 18 intersects or passes by side frame members 32. In this way, hooks 36 cradle growing tube 18 and securely hold growing tube in place on frame 16. Alternatively, it is hereby contemplated that growing tube 18 is connected to frame 16 by any other manner or means such as and including passing a conventional fastener, such as a screw or bolt, through growing tube 18 and into frame, using a strap, a belt, a zip-tie, a shelf, or any other manner or method of connecting two components together.

Growing tube 18 is connected to frame 16. Growing tube 18 is formed of any suitable size, shape and design. In one arrangement, as is shown, growing tube 18 is formed of a generally cylindrical tube that extends between an upper end 38 and a lower end 40 and wraps or snakes around frame 16 in an iterative nature as it extends downward at an angle. Growing tube 18 is either formed of a flexible member, or a rigid member.

In the arrangement shown, growing tube 18 is formed of a conventional piece of rigid polyvinyl chloride (PVC) tubing. Using PVC tubing provides the benefits of being readily available at almost any hardware store, being very strong and durable, having well known properties, being waterproof, and being easy to handle, cut, machine and assemble. In the arrangement shown where rigid PVC tubing is used for growing tube 18, a plurality of straight sections 42 of tubing are used and are connected to corners 44. Straight sections 42 are positioned at a downward angle and extend between opposing side frame members 32. Corners 44 connect to the ends of the straight sections 42 and help curve around the side frame members 32 such that the straight sections 42 iterate between opposing sides of the frame 16.

In the arrangement shown, as one example, growing tube 18 includes four straight sections 42 and three corners 44. The first straight section 42.1 is positioned on the forward side of frame 16 and begins at upper end 38 adjacent one side frame member 32 and extends to the other side frame member 32 at a slight downward angle so as to ensure fluid flows from the upper end 38 down towards the lower end 40 of growing tube 18. A second straight section 42.2 is positioned on the rearward side of frame 16 and begins at an upper end positioned slightly below the lower end of the first straight section 42.1 and extends to the other side frame member 32 at a slight downward angle. A third straight section 42.3 is positioned on the forward side of frame 16 and begins at an upper end positioned slightly below the lower end of the second straight section 42.2 and extends to the other side frame member 32 at a slight downward angle. A fourth straight section 42.4 is positioned on the rearward side of frame 16 and begins at an upper end positioned slightly below the lower end of the third straight section 42.3 and extends at a slight downward angle before connecting to the reservoir 20. It is contemplated that straight sections 42.1, 42.2, 42.3 and 42.4 can angle downward at any angle between 0 and 90 degrees, however using an angle between 1 and 30 degrees has been tested with success, and an angle between 1 and 15 degrees has also been tested with success. The angle of the straight sections 42 determines or affects the speed at which the fluid flows down the growing tube 18. As such, the angle of straight sections 42 can be adjusted, according to the desired speed of fluid flow and application variables. In the arrangement shown, all straight sections angle at approximately the same downward pitch thereby creating approximately equal fluid flow throughout the length of growing tube 18. Alternatively, each straight section 42 can be positioned at its own independent angle thereby providing variable fluid flow across the length of growing tube 18.

The lower end of the first straight section 42.1 is connected to the first corner section 44.1. The first corner section 44.1 serves to curve the growing tube 18 around side frame member 32 from the front of frame 16 to the rear of frame 16. In this way, the first corner section 44.1 connects the lower end first straight section 42.1 on the front side of side frame member 32 with the upper end of the second straight section 42.2 on the rear side of side frame member 32. The lower end of the second straight section 42.2 is connected to the second corner section 44.2. The second corner section 44.2 serves to curve the growing tube 18 around side frame member 32 from the rear of frame 16 to the front of frame 16. In this way, the second corner section 44.2 connects the lower end second straight section 42.2 on the rear side of side frame member 32 with the upper end of the third straight section 42.3 on the front side of side frame member 32. The lower end of the third straight section 42.3 is connected to the third corner section 44.3. The third corner section 44.3 serves to curve the growing tube 18 around side frame member 32 from the front of frame 16 to the rear of frame 16. In this way, the third corner section 44.3 connects the lower end third straight section 42.3 on the front side of side frame member 32 with the upper end of the fourth straight section 42.4 on the rear side of side frame member 32. The lower end of the fourth straight section 42.4 then fluidly connects to reservoir 20.

As all three corner sections 44.1, 44.2, 44.3 serve to wrap the growing tube 18 around a side frame member 34, and change the direction of the growing tube 18 to point in the opposite direction, corner sections 44 are formed of a pair of elbow sections 46 that each curve approximately 90 degrees. These elbow sections 46 are connected to own another at their outward ends along, a seam line 48. The two connected elbow sections 46 are angled with respect to one another so as to continue the downward angle of the growing tube 18.

Growing tube 18 includes a plurality of opening 50 therein. Openings 50 are any opening, orifice, gap or space in the surface of growing tube 18 into which a plant 30, root systems 28 of plant 30 are inserted into growing tube 18. In one arrangement, as is shown, openings 50 are approximately equally spaced along the upper surface of straight sections 42. In one arrangement, as is shown, openings 50 are generally circular shaped openings cut into the growing tube 18. To facilitate easy insertion of plants 30 and root systems 28 of plants 30, baskets 52 are inserted into the openings 50 and the plants 30 are placed in the basket. It is hereby contemplated that growing tube 18 can be formed of any other suitable size, shape or design.

Reservoir 20 is formed of any suitable size, shape or design. Reservoir 20 serves to hold the nutrient rich water used to grow plants 30. In the arrangement shown, reservoir 20 is generally square or rectangular in shape and is positioned on the rearward side of frame 16 and sits upon either or both of the lower end frame member 34 and the leg of base 14, or is connected to or fastened to lower end frame member 34 and the leg of base 14. Connecting reservoir 20 to stand 12 makes it easier to move system 10 as all components are connected to one another and thereby move together.

Pump 22 is operatively connected reservoir 20 and serves to pump the nutrient rich water through the system 10. Pump 22 is any device that moves water through the system. In one arrangement, pump 22 is positioned within reservoir 20 and submerged within the fluid therein. In an alternative arrangement, an inlet end of pump 22 is fluidly connected to reservoir 20 and is external to reservoir 20, such as being fluidly connected to a sump, drain or other opening in reservoir. An outlet end of pump 22 is fluidly connected to hose 24 which serves as a fluid conduit to pump fluid through the system 10.

Hose 24 is formed of any suitable size, shape and design and serves to transport fluid from reservoir 20 and/or pump 22 to the upper end 38 of growing tube 18. In the arrangement shown, hose 24 is a generally flexible cylindrical tube that extends from reservoir 20 and/or pump 22 to the upper end 38 of growing tube 18.

In one arrangement, hose 24 terminates at or near the upper end 38 of growing tube 28. in this arrangement, hose 24 serves to transport the nutrient rich fluid to the upper end 38 of growing tube 18, which then flows downward under the force of gravity through the growing tube before ending back in reservoir 20, In this arrangement, the hose 24 simply pours or sprays the fluid into the growing tube 18 at or adjacent its upper end 38. In this arrangement, the hydroponic system 10 is a Nutrient Film Technique (N.F.T.) hydroponic system. That is, in this arrangement, the nutrient rich fluid continuously or intermittently flows through growing tube 18 in small amounts forming a thin film of flowing nutrient rich fluid on the inside surface of growing tube 18. The roots systems 28 of plants 30 within growing tube 18 reach down to this flowing film of fluid and absorb the fluid and nutrients therein.

In another arrangement, hose 24 extends from the reservoir 20 and/or pump 22 and down all or a portion of growing tube 18. In this arrangement hose 24 includes a plurality of openings 54 or nozzles 56 therein that spray nutrient rich fluid within growing tube 18 at the location of each opening 54 or nozzle 56. In one arrangement, one or more opening 54 or nozzle 56 is positioned adjacent each opening 50 in growing tube. That is, in this arrangement, the openings 54 or nozzles 56 are positioned within growing tube 18 precisely at the position where plants 30 are inserted into the growing tube. in this arrangement, the openings 54 or nozzle 56 are designed to spray the nutrient rich fluid directly onto the root systems 28 of plants 30. In this way, hydroponic system 10 is an Aeroponic system. That is, in this arrangement, the root systems 28 of plants 30 hang in the air and are continuously or intermittently sprayed with the nutrient rich fluid. In one arrangement, the hosing 24 within growing tube 18 is positioned adjacent the upper outward edges of openings 50 in growing tube 18. This allows the nutrient rich water to be sprayed outwardly and/or downwardly onto the root systems 28. This provides better coverage of fluid on the root systems 28 and reduces or eliminates the fluid from spraying out of growing tube 28 through openings 50 as would be the case if the hose 24 was positioned at the bottom of growing tube 18. In one arrangement, a single hose 24 is positioned on one side of the interior surface of growing tube 18 with openings 54 or nozzle 56 positioned adjacent each opening 50 in the growing tube; whereas in another arrangement, a pair of hoses 24 are positioned within the rowing tube 18, one on either side of the interior surface of growing tube 18 with openings 54 or nozzle 56 positioned adjacent each opening 50 in the growing tube 18. Using two hoses 24 within growing tube 18 provides additional coverage for root systems 28 and allows for more consistent and less lopsided root growth, whereas in other arrangements using a single hose 24 within growing tube 18 is more than sufficient. In this arrangement, openings 54 are simply punctures into hose 24, whereas nozzles 56 are additional components connected to hose 24, by any manner such as threading nozzles 56 into hose 24 at the appropriate locations, gluing nozzles 56 into hose 24 at the appropriate locations, welding nozzles 56 into hose 24 at the appropriate locations, strapping nozzles 56 onto hose 24 at the appropriate locations, or connecting nozzles 56 into hose 24 at the appropriate locations by any other manner or means. In this arrangement, to ensure proper pressure is maintained through the hose 24 a cap 58 is placed at the lower end of hose 24 thereby closing the lower end and ensuring the fluid must pass through the openings 54 or nozzles 56 instead of simply pouring out the end of hose 24.

In yet another arrangement, hydroponic system 10 utilizes both of the above described systems thereby harnessing, the benefits of both N.F.T and Aeroponics. That is the hydroponic system 10 includes a hose 24 that simply pours nutrient rich fluid into or adjacent the upper end 38 thereby allowing it to flow down the growing tube 18 in a thin film, as well as having hose 24 that extends through the growing tube 18 with openings 54 or nozzles 56 therein that spray nutrient rich fluid onto the root structures 28 of plants 30.

In Operation: Hydroponic system 10 is formed by building stand 12 out of base 14 and frame 16 and a plurality of hooks 36 are connected to the frame 16 at the appropriate locations. Next, growing tube 18 is formed out of a plurality of straight sections 42 connected to corner sections 44. The straight sections 42 are hung in the hooks 36 and the corner sections 44 connected the ends of adjacent straight sections 42. A reservoir 20 is connected to stand 12 and the lower end 40 of growing tube 18 is connected to the reservoir 20. Once assembled, the parts are glued together to ensure a water tight seal between parts.

Next, hose 24 is connected to pump 22 or reservoir 20 and the hose 24 is fed to the upper end 38 of growing tube 18. In the arrangement wherein the hydroponic system 10 is a N.F.T. system, the hose 24 terminates in an open end adjacent the upper end of the growing tube 18. In the arrangement wherein the hydroponic system 10 is an Aeroponic system, the a plurality of nozzles 56 are affixed to the hose 24 or a plurality of openings 54 are placed in the hose 24 at the appropriate locations and the hose 24 is inserted into the grow tube 18 and affixed such that it is in the proper location (such as the upper interior portion of growing tube and adjacent the outward sides of openings 50 in the growing tube) and oriented such the openings 54 and/or nozzles 56 point in the right direction.

Next, once the hydroponic system 10 is fully assembled, baskets 52 are inserted in the openings 50 and the root systems 28 of plants 30 are placed in each opening 50, the reservoir 20 is filled with nutrient rich fluid and the pump 22 is activated. Once activated the hose 24 either or both sprays fluid through openings 54 or nozzles 56 onto root structures 28, and/or pours a thin film of fluid into growing tube 18 that is absorbed by root systems 28.

This arrangement provides optimal growing opportunities for plants 30 and precise control of the nutrients within the fluid as well as optimal placement of the fluid onto the root systems 28 of plants 30.

Ornamental Appearance: In one arrangement, as is shown, one material used to form growing tube 18 is conventional PVC. Conventional PVC comes in a limited number of colors, including black, gray and white. White is preferred by many consumers, however in many applications white is unappealing as it is antiseptic in appearance. Accordingly, to improve the aesthetic appearance of the hydroponic system 10 the white PVC tubing is treated to have the appearance of bamboo, named by applicant as “Fauxboo.” This is accomplished, in one arrangement, by performing the following steps.

First, the desired size, length and variety of PVC is selected. In the arrangement shown, white schedule 40 PVC is selected that conventionally comes in sizes ranging from 1/2 to 6 in. in diameter or larger, and lengths up to 12 ft. or longer.

Next, the PVC tube is thoroughly cleaned to remove any dirt, grease, oil and any of the printing placed on the tube from the manufacturer. This process also removes or pulls out the impurities from the porous material prior to refinishing the tubing. In one arrangement acetone or lacquer thinner are used, however any other effective cleaning process or product is employed.

Next, the cleaned tube is placed into a lathe to where it is turned and grooves are formed in the surface of the tube at spaced intervals along its length. These grooves mimic the growth rings of the stem of bamboo plants. The spacing and depth of these grooves is depends on the size of the tubing selected; when using a 1 in. tubing the wall thickness is thinner and therefore the depth of the groove is less and the grooves are placed closer together; when using a 6 in. tubing the wall thickness is thicker and therefore the depth of the groove is greater and the grooves are placed further apart from one another. In one arrangement, when ½ in. to 1 in. tubing is used, the grooves are positioned from 2 in. to 4 in. apart from one another; when 2 in. to 4 in. tubing is used, the grooves are positioned 10 in to 18 in. apart from one another; when larger tubing is used the grooves are positioned from 12 in. to 20 in. apart from one another. However any other spacing is hereby contemplated. In one arrangement the grooving is approximately half the thickness of the wall thickness of the tubing; however any other depth is hereby contemplated for use such as 15%, 20%, 25%, 30%, 35%, 40%, 45%, 55%, 60%, 65%, 70%, 75%, 80%, 85%, 90%, or more or less.

In one arrangement, the grooves are formed by hand using carving blades and each groove when cut is 2 step cut. The blade is used to create a right groove and then a left groove. The reason this is done to these depths is for the heating process so when the pipe is heated and torched at the joints it compresses together to give it a natural joint look, as is further described herein.

Next, the grooves are heated to give the groove the visual appearance of a bamboo joint or ring. Each joint is heated with a torch using a three step process per joint. With the tube on the lathe the torch is placed in the center of the groove as the tube is rotated. Once this area is heated to the point where the pipe is pliable, the heat is moved to the right and left sides of the groove. This is done is to shrink the joint so it can come together, providing a unique aesthetic appearance. Burning and shrinking the joint in this manner also blackens the exterior surface of the tube at the joint, which also gives the joint the natural look and feel of bamboo. Another feature of this process is that when the joint is heated and compressed, this causes a ripple, bulge or ring in the interior wall of the tubing. This inwardly extending ring or bulge causes the fluid flowing through the interior of the tubing to slightly puddle and slow down as it travels by gravity through the tube which can be desirable in many applications.

Next, after the joint burning process is complete, the tube is removed from the lathe and moved to a belt sander or other sanding device. In one arrangement, a large belt sander using generally rough grit sand paper (such as 800 grit) is applied to the surface of the tube. This gives the tube imperfections in the surface of the tube giving the tube a natural grooved or worn look. Care is taken to create scratches in the surface of the tube that extend in parallel alignment with the length of the tube like the striations present in natural bamboo, however any other alignment is hereby contemplated for use such as perpendicular to the length or at any angle between perpendicular and lengthwise.

Next, the surface of the tube is again torched in various places providing distinct and unique features in each tube. Again, this unique process gives the PVC tubing the natural look and feel of the bamboo.

Next, the tube is allowed to cool and then the surface of the tube is sanded with generally fine grit sand paper (such as 1000 grit). This sanding provides imperfections in the burned or charred parts of tube. Because the charred parts of the tube are dark or black and the underlying tubing is white, by sanding the charred parts of the tubing the underlying white color can be brought out providing light striations in the dark portions of the charring. This also allows the user to lighten the dark joints. That is, by rubbing the sand paper on the edges of the grooves at each joint, this lightens the joints and brings attention to them. Again, making the fabricated joints appear more natural.

Next, the pipe is thoroughly cleaned using acetone, lacquer thinner or any other cleaning agent or process to remove impurities prior to the refinishing process.

Next, once cleaned, the tube is coated with one or more layers of a sealing and protecting coat such as clear coat, shellac or the like. This coat helps to provide a natural tone to the surface of the tube and provides a transparent look with a desirable tan finish. Shellac or similar products are desirable because they dry quickly. In one arrangement, three layers are sprayed onto the tube and the tube is cured between layers or after all layers are applied.

As an option, prior to or after or between the coating steps, optional coloring is added. Any color can be used including earth tones, such as grey, brown, tan, etc. or bright colors, such as red, orange, yellow, green, blue, indigo, violet, or the like. The coloring can be added to the surface of the tubing, such as a penetrating stain or paint, or otherwise, the coloring can be added to the coating product, such as shellac. In one arrangement, a natural brown, tan or green color is added to the coating (shellac) by aniline toner which, in one arrangement, comes as a concentrated powder product.

In this arrangement, to achieve a desired finish, a small amount of aniline powder (such as between ½ teaspoon to up to 1 tablespoon) is added to 8 ounces of shellac, which are then mixed thoroughly and allowed to set for approximately 30 minutes to ensure proper dissolving has occurred before spraying or painting. In another arrangement, glycol base colorants are used or other additives are used.

After the base and color process are performed, the tube is refinished with an enamel protective clear coat to ensure longevity of our product for years to come. The process is the again done with 3 coats of enamel material with a desired thickness of 3-5 mils to give the product the proper protective coating and sheen.

This process converts an antiseptic looking PVC tube to have a desirable natural looking bamboo appearance. In addition, the product is cost effective, user friendly and has a long useful life.

Not only can the treated tubing 100 be used for the hydroponic system 10 presented herein, but the product can be used for any purpose. As one example, the treated tubing 100 can be used for horizontal planters 102 where dirt is placed within the hollow interior of the tube 18 and the plants 30 are planted in the openings 50 in the tubing 18. As another example, the treated tubing 100 can be used in vertical planters 104 wherein dirt is placed in the hollow interior of the tubing 18 and a plant 30 is placed in the open end of the tubing 18; and an assortment of tubes 18 can be arranged together in potting arrangements. As other examples, the treated tubing 100 can be used as trim for building projects and decorations, for building tiki huts, or for any other application where PVC tubing is used or an aesthetically pleasing tube or piece of tube is applicable.

Accordingly, from the above discussion it will be appreciated that the improved hydroponic system presented herein improves upon the present state of the art; that grows high quality plants; that optimizes plant growth; is easy to use; is aesthetically pleasing; is efficient to use; can be used to grow multiple plants at a time; allows for easy control of nutrient levels; that applies nutrient rich fluid in an efficient manner to the roots of plants; is relatively inexpensive; has a unique design; has a minimum number of parts; is convenient to use; is self-standing; is modular and can be expanded; has an intuitive design; is inexpensive to use; operates using and harnesses the benefits of both Nutrient Film Technique (N.F.T.) and Aeroponics; is inexpensive to use, among countless other improvements and advantages.

It will be appreciated by those skilled in the art that other various modifications could be made to the device without parting from the spirit and scope of this invention. All such modifications and changes fall within the scope of the claims and are intended to be covered thereby.

What is claimed is:

1. A hydroponic system, comprising:
a stand;
a growing tube connecting to the stand;
the growing tube having a hollow interior and extending from an upper end and a lower end;
the growing tube having a plurality of openings in an upward facing surface;
a reservoir fluidly connected to the lower end of the growing tube;
a pump and hose fluidly connected to the reservoir;
wherein the pump supplies pressurized nutrient rich water to the hose;
wherein the hose extends through a length of the growing tube; and
wherein the hose includes a plurality of nozzles therein, such that the nozzles spray nutrient rich fluid on the root systems of plants placed in the openings in the growing tube.

2. A method of making faux bamboo, the steps comprising:
selecting a tube;
cutting a plurality of grooves in the surface of the tube;
heating the grooves in the tube to provide a charred appearance; and
coating the tube with a protective coating.
